(19) United States
(12) Patent Application Publication
(10) Pub. No.: US 2011/0107863 A1
(43) Pub. Date: May 12, 2011

(54) HYBRID POWER DRIVING SYSTEM

(76) Inventors: Yi Ren, Shenzhen (CN); Shenglin Yang, Shenzhen (CN); Jun Li, Shenzhen (CN)

(21) Appl. No.: 12/944,635

(22) Filed: Nov. 11, 2010

(30) Foreign Application Priority Data
Nov. 11, 2009 (CN) 200910221641.9

(51) Int. Cl. F16H 61/30

(52) U.S. Cl. 74/473.11

(57) ABSTRACT

A hybrid power driving system of the present invention comprises an engine, a first clutch, a transmission mechanism including a transmission shaft, a first motor, a power supply and a hydraulic control system. The hydraulic control system may comprise an oil container; a first hydraulic cylinder which includes a cylinder and a piston to perform a reciprocating motion along the inner wall of the cylinder, used for controlling the engagement of the first clutch; a first oil pump driven by the first motor, configured to supply hydraulic oil from the oil container to the cylinder barrel of the first hydraulic cylinder; a controller which is electrically coupled with the first motor. The hydraulic control system may further comprise an additional motor and a second oil pump. The additional motor is electrically coupled with the power supply and the controller respectively. The second oil pump is driven by the additional motor, used for supplying hydraulic oil from the oil container to the cylinder barrel of the first hydraulic cylinder.

### CROSS-REFERENCE TO RELATED APPLICATIONS

The present application claims priority to and benefits of Chinese Patent Application No. 200910221641.9 filed with Chinese SIPO on Nov. 11, 2009, the entirety of which is hereby incorporated by reference.

### BACKGROUND

1. Technical Field

The present invention relates to a hybrid power driving system.

2. Description of the Related Art

Generally, hybrid power driving systems in the prior art use a hybrid control system to control clutches or brakes so as to transmit power in a desired mode.

Typically, a prior art hybrid power driving system comprises an engine, a transmission and an electric motor. The engine is coupled to the input shaft of the transmission via a clutch, and the electric motor is also coupled to the input shaft of the transmission. As a result, powers from the engine and electric motor are coupled by the transmission.

A hybrid power vehicle is typically started under the power of the electric motor. Thus, at the start of the vehicle, the oil pump in the hydraulic control system is driven by the electric motor. After the electric motor starts its normal operation, the oil pump in the hydraulic control system starts to operate normally to provide power needed to control system components such as a clutch.

However, before the start of the vehicle, the clutch between the engine and the transmission is engaged. When the electric motor starts the vehicle when the clutch is engaged, the power of the electric motor may be transmitted to the engine via the transmission and the electric motor generates a drag (or load) on the engine, which may easily damage the cylinders of the engine.

Accordingly, a hybrid power driving system is needed to avoid damage to the engine when a hybrid vehicle is started.

### SUMMARY

The present invention is directed to solving at least one problem associated with the prior art. Accordingly, in order to avoid possible damage to the engine during the start of a vehicle in a traditional hybrid power driving system, the present invention provides a hybrid power driving system which can avoid damage to the engine.

According to an embodiment of the present invention, a hybrid power driving system comprises an engine, a first clutch, a transmission mechanism including a transmission shaft, a first electric motor, an electric power supply and a hydraulic control system. The engine may be coupled with the transmission shaft via the first clutch. The first electric motor is electrically coupled with the electric power supply, and the shaft of the first electric motor is coupled with the transmission mechanism. The hydraulic control system comprises:

an oil container for storing the hydraulic oil;

a first hydraulic cylinder which includes a cylinder barrel and a piston to perform a reciprocating motion along the inner wall of the cylinder; the piston is coupled with the first clutch and configured to control the engagement or disengagement of the first clutch; and

a first oil pump, which is driven by the first electric motor; the first oil pump is configured to connect the oil container and a first hydraulic cylinder and used to supply the hydraulic oil in the oil container to the first hydraulic cylinder; and

a controller which is electrically coupled with the first electric motor;

wherein the hydraulic control system further comprises an additional electric motor and a second oil pump. The additional electric motor is electrically coupled with the electric power supply and the controller respectively. The second oil pump is driven by the additional electric motor. The second oil pump is configured to connect the oil container and the first hydraulic cylinder and used to supply the hydraulic oil in the oil container to the first hydraulic cylinder.

At the start of the vehicle, the controller may be used to control the additional electric motor, and the second oil pump may supply pressurized oil to the first hydraulic cylinder so as to disengage the first clutch to disconnect the engine from the shaft of the transmission mechanism. Then the controller may begin to control the operation of the first electric motor, and the power from the first electric motor may not be transmitted to the engine by the transmission mechanism. As a result, damage to the engine may be avoided to achieve a purpose of the present invention.

### BRIEF DESCRIPTION OF THE DRAWINGS

These and other aspects and advantages of the invention will become apparent and more readily appreciated from the following descriptions taken in conjunction with the drawings in which:

FIG. 1 shows a schematic diagram showing the hybrid power driving system according to a preferred embodiment of the present invention;

FIG. 2 shows a schematic diagram showing the hybrid power driving system according to another preferred embodiment of the present invention;

FIG. 3 shows a schematic diagram showing how the engine, the second electric motor, and the transmission shaft of the transmission mechanism are connected; and

FIG. 4 is a schematic diagram showing how the second hydraulic cylinder of the hydraulic control system in the hybrid power driving system is connected in the hybrid power driving system according to a further preferred embodiment of the present invention.

The reference numerals of the main components in the figures are as follows:

| | |
|---|---|
| engine | 1 |
| flying wheel | 2 |
| driven part of the first clutch 4 | 3 |
| first clutch | 4 |
| driving part of the first clutch 4 | 5 |
| clutch cover | 6 |
| diaphragm spring | 7 |
| bearing | 8 |
| first hydraulic cylinder | 9 |
| first sensor | 10 |
| first damping orifice | 11 |
| second electromagnetic valve | 12 |
| first hydraulic accumulator | 13 |
| third electromagnetic valve | 14 |
| second hydraulic accumulator | 15 |
| fourth electromagnetic valve | 16 |
| first electromagnetic valve | 17 |
| second damping orifice | 18 |
| second hydraulic cylinder | 19 |
| third sensor | 20 |
| third damping orifice | 21 |
| second sensor | 22 |
| safety valve | 23 |
| first check valve | 24 |
| second oil pump | 25 |
| first oil pump | 26 |
| first electric motor | 27 |
| transmission mechanism | 28 |
| half shaft and wheel | 29 |
| lubricating oil (hydraulic oil) | 30 |
| filter | 31 |
| shaft of the second electric motor 34 | 33 |
| second electric motor | 34 |
| stator of the second electric motor 34 | 35 |
| transmission shaft | 36 |
| cylinder barrel of the first hydraulic cylinder 9 | 37 |
| piston of the first hydraulic cylinder 9 | 38 |
| cylinder barrel of the second hydraulic cylinder 19 | 40 |
| piston of the second hydraulic cylinder 19 | 41 |
| second check valve | 42 |
| additional electric motor | 43 |
| oil container | 44 |
| controller | 45 |
| electric power supply | 46 |

### DETAILED DESCRIPTION

Reference will be made in detail to embodiments of the present invention. The embodiments described herein with reference to drawings are explanatory and illustrative, and are used to generally understand the present invention. The embodiments shall not be construed to limit the present invention. The same or similar elements and the elements having same or similar functions are denoted by like reference numerals throughout the descriptions.

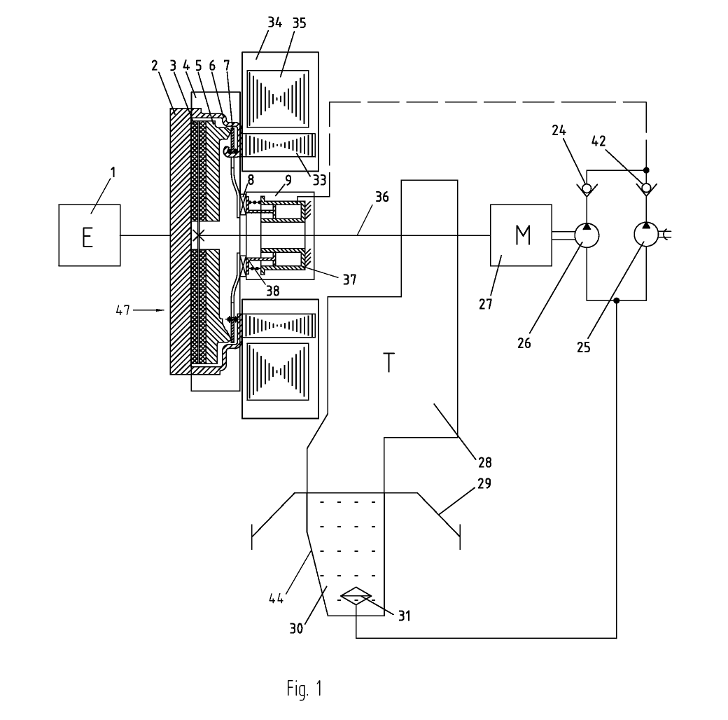

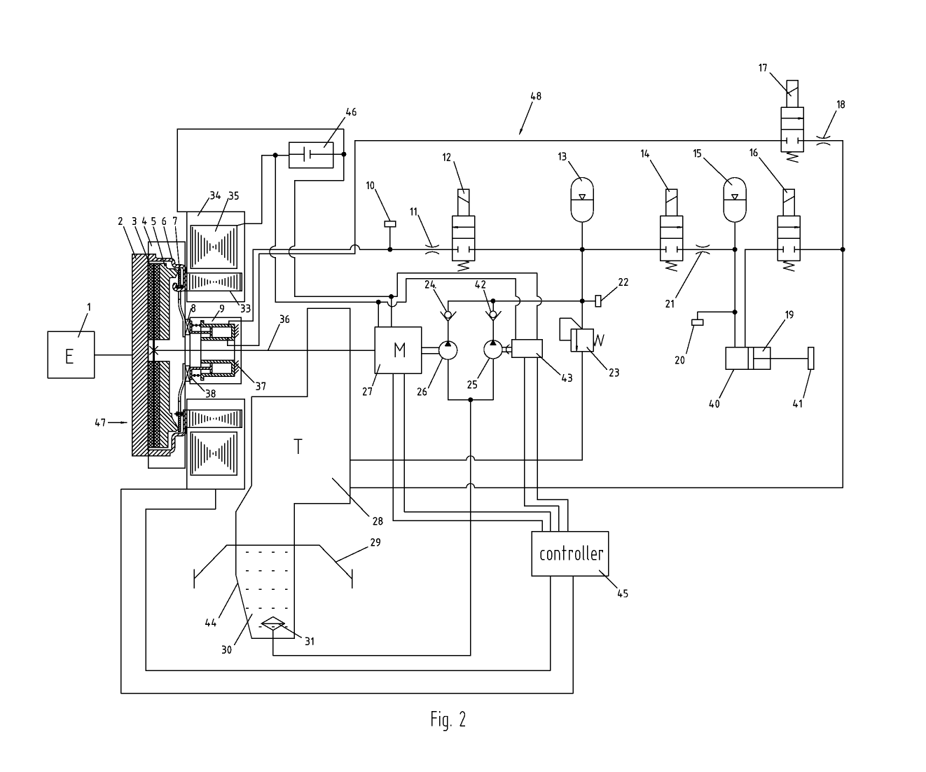

As shown in FIGS. 1 and 2, an embodiment of the present invention provides a hybrid power driving system comprising an engine 1, a first clutch 4, a transmission mechanism 28 including a transmission shaft 36, a first electric motor 27, an electric power supply 46 and a hydraulic control system. The engine 1 is coupled with the transmission shaft 36 via the first clutch 4. The first electric motor 27 is electrically coupled with the electric power supply, and the shaft of the first electric motor 27 is coupled with the transmission mechanism 28.

The hydraulic control system comprises:

an oil container 44 for storing the hydraulic oil;

a first hydraulic cylinder 9, which comprises a cylinder barrel 37 and a piston 38 to perform a reciprocating motion along the inner wall of the cylinder barrel 37, wherein the piston 38 is coupled with the first clutch 4 to control the engagement or disengagement of the clutch 4;

a first oil pump 26, which is driven by the first electric motor 27, wherein the first oil pump 26 is configured to connect the oil container and the first hydraulic cylinder 9 and is used to supply the hydraulic oil in the oil container to the cylinder barrel of the first hydraulic cylinder 9; and

a controller 45, which is electrically coupled with the first electric motor 27.

The hydraulic control system further comprises an additional electric motor 43 and a second oil pump 25. The additional electric motor is electrically coupled with the electric power supply and the controller. The second oil pump 25 is driven by the additional electric motor. The second oil pump 25 is configured to connect with the oil container and the first hydraulic cylinder 9 and to supply the hydraulic oil in the oil container to the first hydraulic cylinder 9.

With reference to the hybrid power control system of the present embodiment, before the first electric motor 27 begins to drive the vehicle, there is no hydraulic power supply in the hydraulic control system to supply pressurized hydraulic oil to actuate the first hydraulic cylinder 9. But the controller may control the additional electric motor to drive the second oil pump 25 to supply pressurized hydraulic oil to the first hydraulic cylinder 9 to disengage the first clutch 4 so as to disconnect the engine 1 from the transmission mechanism 28. Additionally, during vehicle operation, the controller may control the additional electric motor to drive the second oil pump 25, and the second oil pump 25 and the first oil pump 26 may be used together as the power supply of the hydraulic control system.

When the engine 1 and the transmission mechanism 28 are disconnected, the first electric motor 27 may start the vehicle without turning the engine shaft, thus avoiding damaging the engine as is the case with the hybrid power driving systems in the prior art.

The oil container in the hydraulic control system may be the hydraulic oil case of the vehicle. Preferably, the oil container includes an oil pan of a transmission that includes the transmission mechanism 28. The lubricating oil stored in the oil pan of the transmission may be used as the hydraulic oil of the hydraulic control system.

The lubricating oil 30 (hydraulic oil) stored in the oil pan of the transmission may not only be used to lubricate the transmission mechanism in the transmission but also be supplied to the hydraulic control system via a filter 31. This makes the structure more compact and reduces the need for hydraulic oil.

During vehicle operation, the heat generated by the transmission mechanism 28 may be transmitted to the lubricating oil stored in the oil pan of the transmission. After the start of the vehicle, the transmission mechanism 28 may agitate the oil in the oil pan to increase the temperature of the oil in the transmission, so as to prevent the oil from freezing or thickening and allow the oil to be pumped. As a result, the heat generated by the operation of the transmission mechanism 28 may be used to heat the hydraulic oil, resulting in energy saving. Thus, this structure is suitable for cold weather at the polar areas of the Earth, such as in Russia, Norway, etc. The use of the lubricating oil of the transmission or the engine the hydraulic oil of the hybrid power driving system may ensure that the hydraulic oil has good viscosity without the need for an extra heater and ensure the reliable operation of the hybrid power control system, while allowing the structure to be more compact.

Preferably, the hybrid power driving system further comprises a second electric motor 34. The output shaft of the engine 1 is coupled with the shaft 33 of the second electric motor 34. The motor shaft 33 may be coupled with the transmission shaft 36 via the first clutch 4 in accordance with FIGS. 1 and 2.

The hybrid power driving system according to FIGS. 1 and 2 includes at least the following driving modes:

When the first clutch 4 is engaged by the hydraulic control system, the engine 1 and the first electric motor 27 may together drive the vehicle, as well as the second electric motor 34. When the first clutch 4 is disengaged by the hydraulic control system, the engine 1 can drive the second electric motor 34 to generate electricity so as to charge the electric power supply (such as various secondary battery packs). If, at that time, the first electric motor 27 is not driving the vehicle, the vehicle is the park and electricity generating mode.

When the first clutch 4 is disengaged and the first electric motor 27 drives the vehicle by itself, the vehicle is the pure electric driving mode.

When the first clutch 4 is engaged and the first electric motor 27 is not driving the vehicle but the engine 1 is driving the vehicle and the second electric motor 34 is generating electricity or idling, the vehicle is the pure engine driving mode.

The transmission mechanism 28 may be used to transmit the power from the power source (including the engine 1 and the electric motors 24, 27) to the half shaft and the wheel 29 so as to drive the vehicle. According to some embodiments of the present invention, the transmission mechanism 28 may be selected from one or more of several transmission mechanisms, such as a gear series mechanism, a planetary gear mechanism and so on.

The electric power supply may be electrically coupled with the first motor 27 and second motor 34 to supply electric power to the first motor 27 and second motor 34. The electric power supply may include one or more of various mobile electric power supplies, such as a lithium-iron secondary cell, a storage battery and so on. The shaft of the second motor 34 may be coupled with the transmission mechanism 28, but the coupling is not limited to the connection between the shaft of the second motor 34 and the transmission shaft 36 in FIGS. 1 and 2 (for example, the transmission shaft 36 may function as the input shaft of the transmission mechanism 28). For example, the shaft of the second motor 34 may be coupled with the output shaft of the transmission mechanism 28 to directly transmit power from the second motor 34 to the half shaft and the wheel 29.

Moreover, the second motor 34 is not necessary. Some embodiments of the present invention may not have the second motor 34. Instead, the output shaft of the engine 1 may be directly coupled with the transmission shaft 36 of the transmission mechanism 28 via the first clutch 4.

In order to reliably control the operation of the first hydraulic cylinder 9, preferably, the hydraulic control system further comprises: a first electromagnetic hydraulic valve 17 for connecting or disconnecting the oil container and the first hydraulic cylinder 9; a second electromagnetic hydraulic valve 12 for coupling the first oil pump 26 and the second oil pump 25 with the first hydraulic cylinder 9; a first sensor 10 for detecting the pressure in the first hydraulic cylinder 9. The controller 45 is electrically coupled with the first electromagnetic valve 17, the second electromagnetic valve 12 and the first sensor 10 respectively, wherein the controller controls the operation of the second oil pump 25 and/or the first oil pump 26 and the opening or closing of the first electromagnetic valve 17 and second electromagnetic valve 12 based on the signal from the first sensor 10 representing the hydraulic oil pressure in the first hydraulic cylinder 9.

Normally, when the first motor 27 is in operation, the first oil pump 26 is also in operation. The connection or disconnection between the first oil pump 26 and the first hydraulic cylinder 9 may be controlled by the second electromagnetic valve 12. To operate the first hydraulic cylinder 9, the first electromagnetic valve 17 is preferably closed and the first oil pump 26 is preferably placed in operation to supply the hydraulic oil stored in the oil container to the first hydraulic cylinder 9 so as to actuate the first hydraulic cylinder 9.

The first sensor 10 may be any sensor that can detect the pressure of hydraulic oil.

The controller (such as a programmable logic controller, a single chip microcomputer, an electronic control unit of the vehicle, and so on) may be electrically coupled with the first sensor 10 to receive the pressure signal from the first sensor 10 and compare the detected hydraulic pressure with a predetermined hydraulic pressure to determine whether the hydraulic pressure in the first hydraulic cylinder 9 is proper and whether the action of the first hydraulic cylinder 9 is proper, such as whether the piston 38 of the first hydraulic cylinder 9 has reached a predetermined position.

The controller may be further electrically coupled with the first electromagnetic valve 17, the second electromagnetic valve 12 and the first electric motor 27. Based on the hydraulic pressure difference detected by the first sensor 10, the controller may control the opening and closing of the first electromagnetic valve 17 and the second electromagnetic valve 12 and the operation of the second oil pump 25 and/or the first oil pump 26 (for example, controlling the rotational speed of the first motor 27).

For example, if the hydraulic pressure in the first hydraulic cylinder 9 detected by the first sensor 10 is less than the predetermined hydraulic pressure, the controller may keep the first oil pump 26 in operation and the second electromagnetic valve 17 closed, to allow the first oil pump 26 to continue to supply hydraulic oil to the first hydraulic cylinder 9 to increase the hydraulic pressure in the first hydraulic cylinder 9. When the hydraulic pressure in the first hydraulic cylinder 9 detected by the first sensor 10 is higher than the predetermined hydraulic pressure, the controller may stop the first oil pump 26, close the second electromagnetic valve 12, and open the first electromagnetic valve 17, to allow the hydraulic oil in the first hydraulic cylinder 9 to be discharged to the oil container to decrease the pressure in the first hydraulic cylinder 9. When the pressure in the first hydraulic cylinder 9 detected by the first sensor 10 is equal to the predetermined hydraulic pressure or within an allowed tolerance range of the predetermined hydraulic pressure, the controller may close the first electromagnetic valve 17 and the second electromagnetic valve 12 so that the hydraulic pressure in the first hydraulic cylinder 9 is kept constant.

From aforementioned description, a hydraulic control system of the hybrid power drive system according to the present invention can accurately control the hydraulic pressure in the first hydraulic cylinder 9 and consequently the application of the first clutch 4.

The first clutch 4 may be any of the dry clutches or wet clutches although it is typically a dry clutch. The first clutch 4 may be used to connect or disconnect the first motor 27 and the engine 1. The piston 38 of the first hydraulic cylinder 9 may be coupled with the first clutch 4 to engage or disengage the first clutch 4 according to the action of the piston 38.

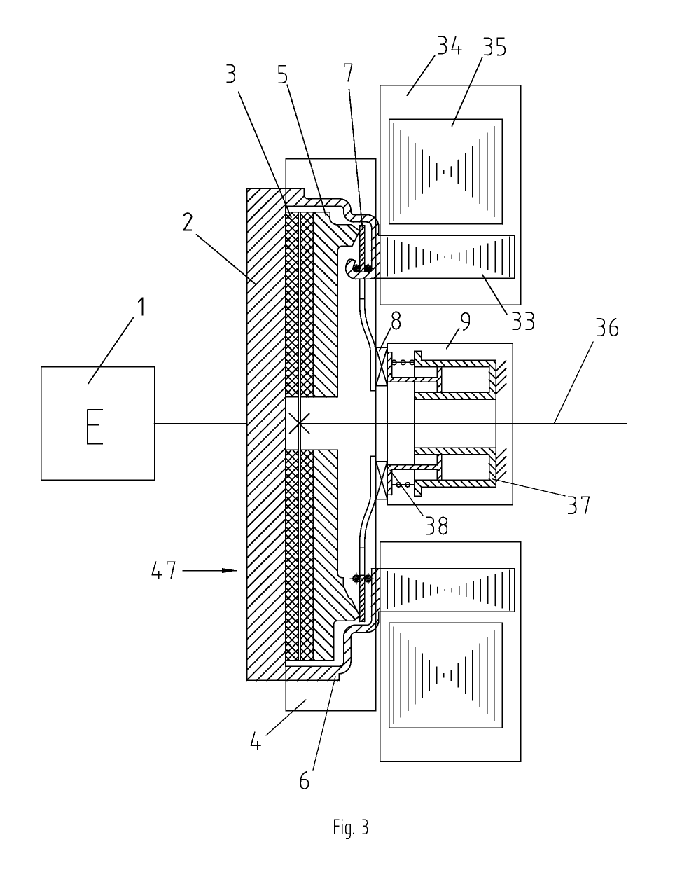

As shown in FIGS. 1, 2 and 3, especially in FIG. 3, in order to make the structure compact so that the first clutch 4 and first hydraulic cylinder 9 can be added, the second motor 34 preferably comprises a stator 35 and a rotator, wherein the motor shaft 33 may be hollow and served as the rotator. The engine 1 may be coupled with the shaft 33 of the second motor 34 via a connector having a chamber, and the first clutch 4 may be located in the chamber of the connector.

The connector may be a part prepared in one body or may comprise multiple components, as long as it can reliably couple the main shaft of the engine 1 and the shaft 33 of the second motor 34. As shown in FIG. 3, the connector may include a flying wheel 2 and a clutch cover 6.

The first clutch 4 may be set in the chamber of the connector configured to couple the engine 1 and second motor 34. The first clutch 4 preferably does not occupy a large space, thus making it possible to have a compact structure. Moreover, the first clutch 4 may be a dry clutch to make the structure more compact. The driven part 3 of the first clutch 4 may be fixedly connected with the transmission shaft 36. And the driving part 5 of the first clutch 4 may be coupled with the piston 38 of the first hydraulic cylinder 9 via a connector, which may comprise, for example, a diaphragm spring 7 and a bearing 8 used as the hydraulic release bearing of the first hydraulic cylinder 9. Alternatively, the driving part 5 of the first clutch 4 may be directly fixedly connected with the piston 38 without the connector. When the driving part 5 of the first clutch 4 slides to engage with the driven part 3, the first clutch 4 is engaged. When the driving part of the first clutch 4 slides to disengage with the driven part, the first clutch 4 is disengaged. The driving part of the first clutch 4 may be controlled by the piston 38 of the first hydraulic cylinder 9.

In an embodiment of the present invention, the first hydraulic cylinder 9 may be located in a hollow part of the shaft 33 of the second motor 34. Therefore, the first hydraulic cylinder 9 preferably is compact. Moreover, the piston 38 of the first hydraulic cylinder 9 may be coupled with the driving part 5 of the first clutch 4. When there is no pressurized hydraulic oil in the first hydraulic cylinder 9, the driving part 5 of the first clutch 4 may be engaged with the driven part 3 to engage the first clutch 4. When the first hydraulic cylinder 9 is supplied with pressurized hydraulic oil, the piston 38 of the first hydraulic cylinder 9 pushes the connector to disconnect the driving part 5 of the first clutch 4 with the driven part 3 to disengage the first clutch 4. In an alternative embodiment, when there is no pressurized hydraulic oil in the first hydraulic cylinder 9, the first clutch 4 may be disengaged; and when there is pressurized hydraulic oil in the first hydraulic cylinder 9, the first clutch 4 may be engaged. In any event, the first clutch 4 may be controlled by the first hydraulic cylinder 9, so that the piston 38 of the first hydraulic cylinder 9 may drive the driving part 5 of the first clutch 4 to engage or disengage the first clutch 4.

In some embodiments of the present invention, there may be one or multiple first hydraulic cylinders 9 selected from the traditional hydraulic cylinders to drive the driving part of the first clutch 4. As shown in FIG. 1, preferably, the cylinder barrel 37 and the piston 38 are annular to allow the transmission shaft 36 to pass through the hollow portion of the annular cylinder barrel 37 and the piston 38.

The connecting relation between the hydraulic control system and the first clutch 4 is described above. The following is a more detailed description of the hydraulic control system of the hybrid power drive system of the present invention.

In some embodiments of the present invention, the hybrid control system may further comprise a first hydraulic accumulator 13, a first check valve 24 and a second check valve 42. The first check valve 24 may be connected with the first oil pump 26 and the second electromagnetic valve 12, and the second check valve 42 may be connected with the second oil pump 25 and the second electromagnetic valve 12. The first hydraulic accumulator 13 may be connected with the first check valve 24, the second check valve 42 and the second electromagnetic valve 12, and may be used to store at least a part of the hydraulic oil passing through the first check valve 24 and/or the second check valve 42 and supply the stored hydraulic oil to the first hydraulic cylinder 9 when the second electromagnetic valve 12 is open.

By means of the first check valve 24, the second check valve 42 and the first hydraulic accumulator 13, pressurized hydraulic oil may be quickly supplied to the first hydraulic cylinder 9.

For example, under a situation where the hydraulic control system is not in operation, where only the first oil pump 26 is in operation, and where the first electromagnetic valve 17 and second electromagnetic valve 12 are closed, the first oil pump 26 supplies pressurized hydraulic oil, through the first check valve 24, to the first hydraulic accumulator 13 hydraulic accumulator for storage. Because of the first check valve 24, the hydraulic oil stored in the first hydraulic accumulator 13 cannot flow back to the oil container.

When the hydraulic control system is in operation, the second electromagnetic valve 12 is open, allowing pressurized hydraulic oil to flow, through the second electromagnetic valve 12, into the first hydraulic cylinder 9 to move the piston 38 of the first hydraulic cylinder 9. The first hydraulic accumulator 13 is closer to the second electromagnetic valve 12 than the first oil pump 26 hydraulic accumulator and therefore can more quickly supply pressurized hydraulic oil to the first hydraulic cylinder 9. Moreover, if the quantity of the hydraulic oil in the first hydraulic accumulator 13 is not sufficient, the first oil pump 26 and the first hydraulic accumulator 13 together can supply the required hydraulic oil to the first hydraulic cylinder 9. The function of the second check valve 42 is similar to the first check valve 24 and will not be described here.

Because the first hydraulic accumulator 13 and the second electromagnetic valve 12 can be placed close to each other, the first hydraulic accumulator 13 can transmit pressurized hydraulic oil to the first hydraulic cylinder 9 more quickly. The path between the first oil pump 26 and the second electromagnetic valve 12 is longer. Transmitting hydraulic oil to the first hydraulic cylinder 9 from the first oil pump 26 requires that the hydraulic oil flows from the oil container to the first hydraulic cylinder 9, a path that is longer than that between the first hydraulic accumulator 13 and the first hydraulic cylinder 9.

In some embodiments, the hydraulic control system may further comprise a second sensor 22 for detecting the pressure of the hydraulic oil in the first hydraulic accumulator 13. The controller may be electrically coupled with the second sensor 22, and the controller may control the operation of the first oil pump 26 according to the pressure of the hydraulic oil in the first hydraulic accumulator 13 detected by the second sensor 22.

If the pressure of the hydraulic oil in the first hydraulic accumulator 13 detected by the second sensor 22 is lower than a predetermined hydraulic pressure (or a tolerance range of the predetermined hydraulic pressure), the controller may control the first oil pump 26 to supply hydraulic oil from the oil container to the first hydraulic accumulator 13. The pressure in the first hydraulic accumulator 13 is increased until the pressure in the first hydraulic accumulator 13 reaches a predetermined pressure level (or within the tolerance range of the predetermined hydraulic pressure). If the pressure in the first hydraulic accumulator 13 detected by the second sensor 22 reaches the acceptable level, the controller may stop or slow down the operation of the first oil pump 26.

In order to prevent the pressure in the first hydraulic accumulator 13 from becoming too high and thus having a negative impact on the hydraulic system, the hydraulic control system may further include a safety valve 23. The safety valve 23 generally functions as a pressure control valve to prevent the pressure in the hydraulic system from exceeding the safe level. For example, the safety valve may be a relief valve or overflow valve. If the pressure in the first hydraulic accumulator 13 does not exceed the allowed level, the safety valve 23 is closed. If the pressure in the first hydraulic accumulator 13 exceeds the allowed level, the safety valve 23 may be open to allow the hydraulic oil in the first hydraulic accumulator 13 to flow into the oil container to relieve the pressure. The safety valve 23 may be electrically coupled with the controller.

In the driving system of the vehicle, there may be a second clutch or brake (not shown). For example, the shaft of the first motor 27 may be coupled with the transmission shaft 36 via the second clutch. Alternatively, the transmission mechanism 28 may comprise a planetary gear mechanism, and the transmission shaft 36 may be fixedly connected with the planetary carrier of the planetary gear mechanism. The shaft of the first motor 27 may be fixedly connected with the sun gear of the planetary gear mechanism. As a result, the power from the engine 1, the first motor 27 and the second motor 34 may be coupled and be transmitted to the half shaft and the wheel 29 of the vehicle.

Preferably, the hybrid control system further comprises:

a second hydraulic cylinder 19, which comprises a cylinder barrel 40 and a piston 41 to perform a reciprocating motion along the cylinder barrel 40;

a third electromagnetic valve 14, which is located between the second hydraulic cylinder 19 and the first hydraulic accumulator 13 and used to control the connection or disconnection between the first hydraulic accumulator 13 and the second hydraulic accumulator 19;

a fourth electromagnetic valve 16, which is used to control the connection or disconnection between the second hydraulic cylinder 19 and the oil container;

a third sensor 20, which is used to detect the hydraulic pressure in the second hydraulic cylinder 19; and

a second hydraulic accumulator 15, which is connected with the third electromagnetic valve 14 and the second hydraulic cylinder 19 and used to store at least a part of the hydraulic oil passing through the third electromagnetic valve 14.

The third electromagnetic valve 14, the fourth electromagnetic valve 16 and the third sensor 20 are electrically coupled to the controller respectively. The controller controls the third electromagnetic valve 14 and the fourth electromagnetic valve 16 based on the hydraulic pressure signal in the second hydraulic cylinder 19 detected by the third sensor 20.

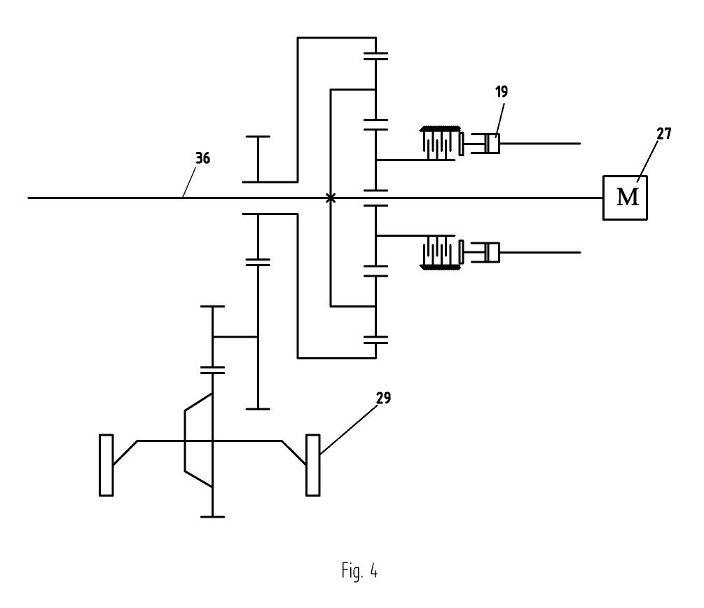

As shown in FIG. 4, by means of the piston 41 of the second hydraulic cylinder 19, the second clutch may be controlled to engage or disengage the second clutch; or at least a sun wheel of the planetary gear mechanism may be braked to achieve different transmission ratios.

The third sensor 20 may detect the stroke position or stroke distance of the piston 41 of the second hydraulic cylinder 19, thus allowing the controller to control the second hydraulic cylinder 19 by controlling the hydraulic pressure in the second hydraulic cylinder 19 by opening or closing the third electromagnetic valve 14, the fourth electromagnetic valve 16 and the operation of the second oil pump 25 for the purpose of, for example, achieving a high stroke accuracy for the piston 41 of the second hydraulic cylinder 19. This can be accomplished in a way that is similar to the control of the stroke accuracy of the piston 38 of the first hydraulic cylinder 9, and therefore does not need to be described here.

The second hydraulic cylinder 19 may be a hydraulic release bearing, which may be coupled with a dry clutch to control the engagement of the dry clutch. Using a hybrid power driving system of the present invention, the hydraulic pressure in the second hydraulic cylinder 19 may be accurately controlled. Thus, the engagement of the dry clutch may be more accurate.

The second hydraulic cylinder 19 may be coupled with the wet clutch in the vehicle to control the action of the wet clutch.

When the second hydraulic cylinder 19 is used to apply the wet clutch, because the hydraulic control system also has the second hydraulic accumulator 15, the second hydraulic accumulator 15 may be connected with the third electromagnetic valve 14 and the second hydraulic cylinder 19, as shown in FIG. 1. Therefore, before pressurized hydraulic oil from the first hydraulic accumulator 13 flows into the second hydraulic cylinder 19 as the third electromagnetic valve 14 opens, the pressurized hydraulic oil may flow into the second hydraulic accumulator 15 first, and may flow into the second hydraulic cylinder 19 after the buffering by the second hydraulic accumulator 15 to avoid the negative effect caused by the hydraulic oil under high pressure directly flowing into the second hydraulic cylinder 19.

In some embodiments of the hybrid control system, pressurized hydraulic oil may be supplied to the first and second hydraulic cylinders by an oil pump (such as the first oil pump 26) and/or a hydraulic accumulator (such as the first hydraulic accumulator 13 or the second hydraulic accumulator 15). When the pressurized hydraulic oil supplied to the hydraulic cylinders is supplied by the hydraulic accumulator, the pressurized hydraulic oil may be quickly supplied to the hydraulic cylinder to increase operation efficiency.

Preferably, the hydraulic control system may further comprise a damping device, which may comprise a first damping orifice 11 between the second electromagnetic valve 12 and the first hydraulic cylinder 9 and a second damping orifice 18 in the pipeline between the first electromagnetic valve 17 and the oil container. The damping device in the hydraulic control system may retard the impact of hydraulic oil under high pressure in operation to avoid its impact on the hydraulic components.

Due to the existence of the first damping orifice 11, the time for transmitting pressurized hydraulic oil to the first hydraulic cylinder 9 may be prolonged, resulting in a lower requirement on the response speed of the second electromagnetic valve 12. Moreover, the second damping orifice 18 may prevent the wet clutch from discharging too much hydraulic oil so as to produce a back pressure.

In some embodiments of the present invention, to retard the impact of pressurized hydraulic oil flowing into the second hydraulic cylinder 19, a third damping orifice 21 may be provided between the third electromagnetic valve 14 and the second hydraulic cylinder 19.

Each of the damping orifices may be of any suitable kind. For example, an orifice may be produced by narrowing the cross section area of a hydraulic pipeline. A throttle valve with an adjustable opening may function as a damping orifice in a hydraulic pipeline.

Normally, the piston of the first hydraulic cylinder 9 connected with the first clutch 4 extends to disengage the clutch 4 and retract to engage the clutch 4. Therefore, the damping coefficient of the first damping orifice 11 is less than that of the second damping orifice 18 to account for the large impact produced by the engagement of the clutch.

Since the damping coefficient of the first damping orifice 11 is less than that of the second damping orifice 18, when pressurized hydraulic oil flows from the first hydraulic accumulator 13 to the hydraulic cylinder 9, the hydraulic oil encounter less damping, and the first clutch 4 may be disengaged quickly. When pressurized hydraulic oil flows from the first hydraulic cylinder 9 to the oil container, passing through the first electromagnetic valve 17 and the second damping orifice 18, the hydraulic oil encounters greater damping, and the engagement of the clutch may be retarded to produce less impact.

The above is a detailed description of the components of the hybrid power drive system according to an embodiment of the present invention and how they are connected. The following is a description of the operation of the hybrid power drive system.

With reference to FIG. 2, with the second electromagnetic valve 12 and the third electromagnetic valve 14 open, the first oil pump 26 supplies hydraulic oil from the oil container to the first hydraulic accumulator 13 though the first check valve 24, so that pressurized hydraulic oil may be stored in the first hydraulic accumulator 13. When the pressure in the first hydraulic accumulator 13 detected by the second sensor 22 is insufficient, the controller may control the operation of the first oil pump 26 according to the hydraulic pressure signal from the second sensor 22 until the pressure in the first hydraulic accumulator 13 detected by the second sensor 22 reaches a predetermined value. When the hydraulic pressure in the first hydraulic accumulator 13 is too high, the safety valve 23 releases hydraulic oil to reduce the pressure. Thus, the hydraulic pressure in the first hydraulic accumulator 13 may be maintained in a reasonable range.

When the first hydraulic cylinder 9 coupled to the first clutch 4 (dry clutch) needs to be actuated, the controller may control the opening of the second electromagnetic valve 12 and the closing of the first electromagnetic valve 17 so that pressurized hydraulic oil in the first hydraulic accumulator 13 may flow into the first hydraulic cylinder 9 through the second electromagnetic 12 to drive the first hydraulic cylinder 9. Moreover, with the cooperation among the first sensor 10, the first electromagnetic valve 17 and the second electromagnetic valve 12, the pressure in the first hydraulic cylinder 9 may be controlled accurately to accurately control the stroke of the piston 38, as described above.

When the pressure in the first hydraulic cylinder 9 needs to decrease, the controller closes the second electromagnetic 12 and opens the first electromagnetic valve 17, allowing the hydraulic oil in the first hydraulic cylinder 9 to flow to the oil container.

When the second hydraulic cylinder 19 coupled to the second clutch (wet clutch) needs to be actuated, the controller opens the third electromagnetic valve 14 and closes the fourth electromagnetic valve 16, allowing pressurized hydraulic oil in the first hydraulic accumulator 13 to flow to the second hydraulic accumulator 15 and then to the second hydraulic cylinder 19 to increase the pressure in the second hydraulic cylinder 19. The third sensor 20, the third electromagnetic valve 14 and the fourth electromagnetic valve 16 cooperate to accurately control the pressure in the second hydraulic cylinder 19. Because of the second hydraulic accumulator 15, the entry of high pressure hydraulic oil into the second hydraulic cylinder 19 does not produce a great impact. When the pressure in the second hydraulic cylinder 19 needs to decrease, the controller closes the third electromagnetic valve 14 and opens the fourth electromagnetic valve 16 to allow the hydraulic oil in the second hydraulic cylinder 19 to flow into the oil container (an oil pan of the transmission).

According to the hydraulic control system in the hybrid power driving system according to an embodiment of the present invention, the stroke of the piston of the hydraulic cylinder may be controlled accurately. Thus the connection and disconnection of power in the hybrid power driving system may be more reliable and accurate. In some embodiments, the controller in the hybrid power driving system may be of any suitable type. For example, the controller may be a control device, such as a Single Chip Microcomputer or a Programmable Logic Controller (PLC) and so on. Also the controller may be an assembly of multiple control devices placed in multiple components of the hybrid power driving system.

According to a hybrid power driving system of the present invention, because the hybrid power driving system has a second oil pump 25, the first hydraulic cylinder 9 may be actuated by the second oil pump 25 to separate the engine 1 and the transmission mechanism 28 so that the engine 1 does not generate a drag on the first motor 27 when the first motor 27 starts the vehicle. During normal operation, the second oil pump 26 may be shut off, and the first oil pump 26 driven by the first motor 27 may function as the pressure source for the hydraulic control system.

Although explanatory embodiments have been shown and described, it would be appreciated by those skilled in the art that changes, alternatives, and modifications can be made in the embodiments without departing from spirit and principles of the disclosure. Such changes, alternatives, and modifications all fall into the scope of the claims and their equivalents.

What is claimed is:

1. A hybrid power driving system comprising:
an engine;
a first clutch;
a transmission mechanism including a shaft;
a first electric motor;
a power supply; and
a hydraulic control system, wherein the engine is coupled with the transmission shaft via the first clutch, wherein the first electric motor is electrically coupled with the power supply, and wherein a shaft of the first electric motor is coupled with the transmission mechanism, the hydraulic control system comprising:
an oil container for storing hydraulic oil,
a first hydraulic cylinder which includes a cylinder and a piston, wherein the piston is coupled with the first clutch and controls the engagement of the first clutch,
a first oil pump that is driven by the first electric motor, wherein the first oil pump connects the oil container with the first hydraulic cylinder and supplies hydraulic oil from the oil container to the first hydraulic cylinder,
a controller which is electrically coupled with the first electric motor,
an additional electric motor, and
a second oil pump, wherein the additional electric motor is electrically coupled with the power supply and the controller respectively, wherein the second oil pump is driven by the additional electric motor, wherein the second oil pump connects the oil container and the first hydraulic cylinder and supplies hydraulic oil from the oil container to the first hydraulic cylinder.

2. The hybrid power driving system of claim 1, wherein the oil container is an oil pan of a transmission including the transmission mechanism, and wherein the oil pan of the transmission further includes lubricating oil which is used as the hydraulic oil for the hydraulic control system.

3. The hybrid power driving system of claim 2, further comprising a second electric motor, wherein the output shaft of the engine is coupled with the shaft of the second electric motor, and wherein the shaft of the second electric motor is coupled with the first clutch and the transmission shaft.

4. The hybrid power driving system of claim 3, wherein the hydraulic control system further comprising:
a first electromagnetic valve for controlling the connection or disconnection between the oil container and the first hydraulic cylinder;
a second electromagnetic valve, via which the first oil pump and the second oil pump are connected with the first hydraulic cylinder; and
a first sensor for detecting pressure in the first hydraulic cylinder, wherein the controller is electrically coupled with the first electromagnetic valve, the second electromagnetic valve and the first sensor respectively, wherein the controller controls operation of the second oil pump and/or the first oil pump and connection or disconnection of the first electromagnetic valve and the second electromagnetic valve according to a signal from the first sensor representing pressure in the first hydraulic cylinder.

5. The hybrid power driving system of claim 4, wherein the hydraulic control system further comprises a first hydraulic accumulator, a first check valve and a second check valve, wherein the first check valve connects the first oil pump and second electromagnetic valve, wherein the second check valve connects the second oil pump and second electromagnetic valve, and wherein the first hydraulic accumulator is connected with the first check valve, the second check valve and the second electromagnetic valve, and is configured to store at least a part of hydraulic oil passing through the first check valve and/or the second check valve and supply the hydraulic oil to the first hydraulic cylinder when the second electromagnetic valve is open.

6. The hybrid power driving system of claim 5, wherein the hydraulic control system further comprises a second sensor for detecting the pressure in the first hydraulic accumulator, wherein the controller is electrically coupled with the second sensor, and wherein the controller controls the first oil pump based on the pressure in the first hydraulic accumulator detected by the second sensor.

7. The hybrid power driving system of claim 6, wherein the hydraulic control system further comprises a safety valve which connects the first hydraulic accumulator and the oil container.

8. The hybrid power driving system of claim 7, wherein the hydraulic control system further comprises:
a second hydraulic cylinder that includes a cylinder and a piston;
a third electromagnetic valve, which controls the connection or disconnection between the first hydraulic accumulator and the second hydraulic cylinder;
a fourth electromagnetic valve that controls the connection or disconnection between the second hydraulic cylinder and the oil container;
a third sensor that detects the hydraulic pressure in the second hydraulic cylinder; and
a second hydraulic accumulator, which is connected with the third electromagnetic valve and the second hydraulic cylinder and is configured to store at least a part of hydraulic oil passing through the third electromagnetic valve, wherein the third electromagnetic valve, the fourth electromagnetic valve and the third sensor are electrically coupled to the controller respectively, and wherein the controller controls the second oil pump and/or the first oil pump and the connection or disconnection between the third electromagnetic valve and the fourth electromagnetic valve based on a signal from the third sensor representing pressure in the second hydraulic cylinder.

9. The hybrid power driving system of claim 6, wherein the hydraulic control system further comprises:
a second hydraulic cylinder that includes a cylinder and a piston;
a third electromagnetic valve, which controls the connection or disconnection between the first hydraulic accumulator and the second hydraulic cylinder;
a fourth electromagnetic valve that controls the connection or disconnection between the second hydraulic cylinder and the oil container;
a third sensor that detects the hydraulic pressure in the second hydraulic cylinder; and
a second hydraulic accumulator, which is connected with the third electromagnetic valve and the second hydraulic cylinder and is configured to store at least a part of hydraulic oil passing through the third electromagnetic valve, wherein the third electromagnetic valve, the fourth electromagnetic valve and the third sensor are electrically coupled to the controller respectively, and wherein the controller controls the second oil pump and/or the first oil pump and the connection or disconnection between the third electromagnetic valve and the fourth electromagnetic valve based on a signal from the third sensor representing pressure in the second hydraulic cylinder.

10. The hybrid power driving system of claim 5, wherein the hydraulic control system further comprises:
a second hydraulic cylinder that includes a cylinder and a piston;
a third electromagnetic valve, which controls the connection or disconnection between the first hydraulic accumulator and the second hydraulic cylinder;
a fourth electromagnetic valve that controls the connection or disconnection between the second hydraulic cylinder and the oil container;
a third sensor that detects the hydraulic pressure in the second hydraulic cylinder; and
a second hydraulic accumulator, which is connected with the third electromagnetic valve and the second hydraulic cylinder and is configured to store at least a part of hydraulic oil passing through the third electromagnetic valve, wherein the third electromagnetic valve, the fourth electromagnetic valve and the third sensor are electrically coupled to the controller respectively, and wherein the controller controls the second oil pump and/or the first oil pump and the connection or disconnection between the third electromagnetic valve and the fourth electromagnetic valve based on a signal from the third sensor representing pressure in the second hydraulic cylinder.

11. The hybrid power driving system of claim 4, wherein the hydraulic control system further comprises:
a second hydraulic cylinder that includes a cylinder and a piston;
a third electromagnetic valve, which controls the connection or disconnection between the first hydraulic accumulator and the second hydraulic cylinder;
a fourth electromagnetic valve that controls the connection or disconnection between the second hydraulic cylinder and the oil container;
a third sensor that detects the hydraulic pressure in the second hydraulic cylinder; and
a second hydraulic accumulator, which is connected with the third electromagnetic valve and the second hydraulic cylinder and is configured to store at least a part of hydraulic oil passing through the third electromagnetic valve, wherein the third electromagnetic valve, the fourth electromagnetic valve and the third sensor are electrically coupled to the controller respectively, and wherein the controller controls the second oil pump and/or the first oil pump and the connection or disconnection between the third electromagnetic valve and the fourth electromagnetic valve based on a signal from the third sensor representing pressure in the second hydraulic cylinder.

12. The hybrid power driving system of claim 7, wherein the hydraulic control system further comprises a damping device which comprises a first damping orifice located between the second electromagnetic valve and the first hydraulic cylinder and a second damping orifice located between the first electromagnetic valve and the oil container.

13. The hybrid power driving system of claim 12, wherein the damping coefficient of the first damping orifice is less than that of the second damping orifice.

14. The hybrid power driving system of claim 6, wherein the hydraulic control system further comprises a damping device which comprises a first damping orifice located between the second electromagnetic valve and the first hydraulic cylinder and a second damping orifice located between the first electromagnetic valve and the oil container.

15. The hybrid power driving system of claim 14, wherein the damping coefficient of the first damping orifice is less than that of the second damping orifice.

16. The hybrid power driving system of claim 5, wherein the hydraulic control system further comprises a damping device which comprises a first damping orifice located between the second electromagnetic valve and the first hydraulic cylinder and a second damping orifice located between the first electromagnetic valve and the oil container.

17. The hybrid power driving system of claim 16, wherein the damping coefficient of the first damping orifice is less than that of the second damping orifice.

18. The hybrid power driving system of claim 4, wherein the hydraulic control system further comprises a damping device which comprises a first damping orifice located between the second electromagnetic valve and the first hydraulic cylinder and a second damping orifice located between the first electromagnetic valve and the oil container.

19. The hybrid power driving system of claim 18, wherein the damping coefficient of the first damping orifice is less than that of the second damping orifice.
